(19) United States
(12) Patent Application Publication
(10) Pub. No.: US 2025/0219513 A1
(43) Pub. Date: Jul. 3, 2025

(54) STEPPER MOTOR MAGNET PIN INSERTION PROCESS

(71) Applicant: Lin Engineering, Inc, Morgan Hill, CA (US)

(72) Inventors: Hoang H. Le, San Jose, CA (US); Nicholas A. Vergara, Gilroy, CA (US); Harlan H. Nguyen, San Jose, CA (US)

(73) Assignee: Lin Engineering, Inc., Morgan Hill, CA (US)

(21) Appl. No.: 18/799,938

(22) Filed: Aug. 9, 2024

Related U.S. Application Data
(60) Provisional application No. 63/615,696, filed on Dec. 28, 2023.

(51) Int. Cl. H02K 15/03

(52) U.S. Cl. CPC H02K 15/03; H02K 2215/00

(57) ABSTRACT

A magnetic pin insertion system comprises a rotary drive of a workpiece (rotor or stator) that a set of axially oriented slots around a circumferential surface that are receptive of magnetic pins. A cartridge holds an axially oriented stack of magnetic pins in guide chutes for each axial section of the workpiece. A pre-loaded feed mechanism (a weight or push spring) pushes the pins into successive slots of the workpiece as the rotary drive rotates the workpiece. Each cartridge chute terminates in an adjustable tongue, with a specified gap from the workpiece, that provides a resistive surface for shearing each pin away from other pins in the stack as they are pushed into their successive slots.

### CROSS-REFERENCE TO RELATED APPLICATION

The present application claims priority under 35 U.S.C. 119(e) from U.S. provisional application 63/615,696, filed Dec. 28, 2023.

### TECHNICAL FIELD

The invention relates to manufacture of dynamo-electric machines, such as stepper motors, and more specifically to the assembling of rotor or stator bodies with permanent magnets, wherein magnet pins are inserted into inter-tooth surface slots or channels on a rotor or stator (workpiece). In particular, the invention relates to improvements to jigs, cartridges, or other arrangements for handling both the workpiece and the magnets to press fit the magnets onto the workpiece with efficiency and cycle time improvements in the assembly process compared to traditional insertion methods.

### BACKGROUND ART

An “enhanced motor” is a term used in the small motor industry to describe a modified hybrid stepper motor having magnetic pin inserts between rotor and/or stator teeth. The enhanced design was originally patented in 1984 by Sigma Instruments under U.S. Pat. No. 4,712,028 which claims an increase in torque of at least 20% over the conventional hybrid stepper motor design. As seen in FIGS. 1A and 1B, this increase is due to the reduction of inherent leakage flux 15 between the stator 11 and rotor teeth 13.

A leakage component 15 shows that not all of the magnetic flux crosses the physical air gap 12 using the shortest path through air. To account for leakage effects, motor designers use Carter's Coefficient (see FIG. 2), which is a coefficient used to calculate the effective air gap based on the magnetic properties, length of the physical air gap, length of the magnet, and areas between the interacting materials. Carter's Coefficient k_{c} is given by:

k_{c}=(wₜ+wₛ)/[wₜ+(1−σ)wₛ],

where wₜ is the width of a tooth at its tip, wₛ is the width of a slot opening between teeth, σ=1 if there is no magnetic pin in the slot, σ=0 if there is a magnetic pin with the same magnetic flux as that over a tooth, and 0<σ<1 if there is a magnetic pin with lower magnetic flux relative to the adjacent teeth. When magnetic pins 17 are added into the equation, Carter's Coefficient approaches a value of 1, where the effective magnetic air gap becomes more representative of the physical air gap 12.

The standard process for inserting the magnet pins 17 between the teeth 13 of a stator 11 (and/or a rotor 13) involves precisely locating and then sliding each magnet pin 17 into an inter-tooth valley in the axial direction (Z, as shown in FIG. 3 for the case of a rotor 23 for a hybrid stepper motor). For example, U.S. Pat. No. 11,637,486 to Akaishi describes a guide device that uses gravity feed to axially insert permanent magnets into slots from above. U.S. Pat. No. 9,929,628 to Ohshima et al. describes an alignment jig device that holds magnet pieces in alignment above holes in a rotor core on a drive unit. The insertion holes in the rotor core axially receive the magnets as they drop by gravity feed from the jig. U.S. Pat. No. 10,447,123 to Amano et al. describes yet another magnet insertion apparatus that uses a push rod to push the magnets from a storage magazine into the holes of a rotor core. To automate this process, precision location and control in the orthogonal X and Y directions is required, normally accomplished in rotary (circumferential) and elevation (radial) axes.

As seen in FIG. 4, to insert the magnet pins 27, e.g. into inter-tooth slots 25 of a rotor 23 (or stator), the magnet pins 27 are normally loaded into a cartridge 29, where individual magnets are fed into each individual slot 25 (the gap between adjacent teeth 24) using a linear motion. The linear motion can be accomplished with pneumatic and/or leadscrew driven push rod 30, where the magnet pins 27 are axially inserted one at a time. After each successful insertion, the workpiece (rotor or stator) is rotated incrementally by the exact gap distance between slots, priming for the next pin insertion. The insertion process is executed singularly for each slot, and for each offset half of a hybrid rotor. This sliding action cycle can take a few seconds per pin. A typical motor can contain from 100 to 200 magnetic pins.

Locating in the elevational or radial Y direction is sensitive due to the tolerance stack up of the fixtures which includes rotary drive assembly, shaft, coupling, and rotor/stator workpiece. Due to the tolerance stack-up in the Y direction, the final positioning of the sliding action can vary greatly which is the known challenge in the industry. When the Y positioning is too high, the magnet pin can twist or even fracture in some cases. When the Y positioning is too low, the magnet will crash into the stator and/or rotor face, causing magnet pin breakage as well. Results are identical for any position errors in the rotary or circumferential X direction. Twisting of a pin during insertion, even when it doesn't break, can result in the magnetic N-S axis to be turned 90° from its intended direction so that it no longer effectively performs its intended magnetic flux leakage reduction function.

In the event a magnet pin breaks during the assembly process, the entire system must be disassembled to clear the magnetic debris from the fixture leading to high cycle times. Cleaning away of the broken pin fragments, often in powder form due to the ceramic nature of these pins, is complicated by the presence in the rotor or stator workpiece of ferromagnetic metal to which the magnetic debris is strongly attracted and to which it tenaciously sticks.

### SUMMARY DISCLOSURE

A magnetic pin insertion system includes a precision machined magnetic pin cartridge with multiple guide channels or chutes (one for each distinct axial section of a rotor or stator workpiece), each chute with its own stack of magnetic pins and capable of resisting the magnetic pins as they feed elevationally (radially) into slots in the workpiece. Rotary motion of the workpiece (rotor or stator) brings each workpiece's slot successively into position and allows mainly gravity, or alternatively a preloaded push spring, to feed magnetic pins into the slots, which are then sheared away from the other pins stacked in the cartridge as the workpiece continues to rotate.

Accordingly, a magnetic pin insertion system in the manufacture of motors comprises a rotary drive and a pin cartridge. The rotary drive continuously rotates a workpiece (rotor or stator) that is being assembled for subsequent use in a motor. The rotary drive rotates the workpiece about a central axis thereof. The workpiece has around its circumferential surface a set of axially oriented slots that are receptive of magnetic pins. The cartridge includes at least one chute. Each chute is associated with a corresponding axial section of the workpiece and holds an axially oriented stack of magnetic pins in guide channels thereof. Each chute of the cartridge also has a pre-loaded feed mechanism that is applied against the stack of magnetic pins to push the pins radially into successive slots of the workpiece as the rotary drive rotates the workpiece. Each guide channel terminates in an adjustable tongue providing a resistive surface for shearing each pin away from other pins in the stack as the pin is pushed into its slot.

For example, the workpiece could be a hybrid rotor having two axially disposed sections with slots that are circumferentially offset between the two sections, with slots of one section aligned with teeth of the other section, and vice versa. The cartridge has two chutes for simultaneously feeding both stacks of the pins into corresponding slots of the respective sections. Because of the independent radial feeding of the two chutes of magnetic pins into the slots and the shearing action at the end of each guide channel's adjustable tongue, the existence of the circumferential offset between the respective sections of slots will be inconsequential to the pin insertion.

The rotary drive could accommodate multiple workpieces. In that case, there will be, in one or more cartridges, as many chutes as the total number of corresponding axial sections of all workpieces attached to the rotary drive.

The pre-loaded feed mechanism of each chute of the cartridge could be a mass that pushes pins downward by gravity into slots of the workpiece situated below the cartridge. Alternatively, the pre-loaded feed mechanism of each chute of the cartridge may be a push spring. The gap between an end of the adjustable tongue and a corresponding top of a slot of the workpiece should be less than half of the thickness of each magnetic pin to discourage any axial turning or twisting of pins as they are fed into successive slots.

This process has measured up to 1700% improvement in overall cycle time, and nearly 100% reduction in magnet pin fracture for substantially improved yields. All pins are automatically loaded in the correct N-S direction without 90° turning so that they can be effective for their intended magnetic flux leak reduction purpose. Each workpiece needs only about 15 seconds to load 100 pins (or, depending on the motor, equivalently about 30 seconds to load 200 pins or one minute to load 400 pins), compared to 12-15 minutes for the prior method when no breaks occur or up to 30 minutes for cleanup whenever breakages occur in the prior method (a prior average rate of about 20 minutes per workpiece). Still further, the invention allows one to add more chutes to the cartridge to load pins onto multiple workpieces without requiring more time. A pin cartridge with two chutes can load 50 pins each for a total of 100 pins onto a workpiece in about 15 seconds, four chutes can load 50 pins each for a total of 200 pins simultaneously onto two workpieces in the same 15 seconds, and equivalently six or eight chutes loading pins onto three or four workpieces simultaneously in 15 seconds. In contrast, the prior loading method multiplies the time required, 100 pins in 15 minutes, 200 pins in 30 minutes, and 400 pins in one hour, assuming no pin breakages occur during that time.

### BRIEF DESCRIPTION OF THE DRAWINGS

FIGS. 1A and 1B are respective closeup elevational views of rotor and stator interfaces for both a standard prior art hybrid stepper motor (FIG. 1A) and an enhanced prior art Sigma Instruments motor (FIG. 1B) with magnet inserts in inter-tooth slots of the stator, illustrating focused or concentrated torque producing flux.

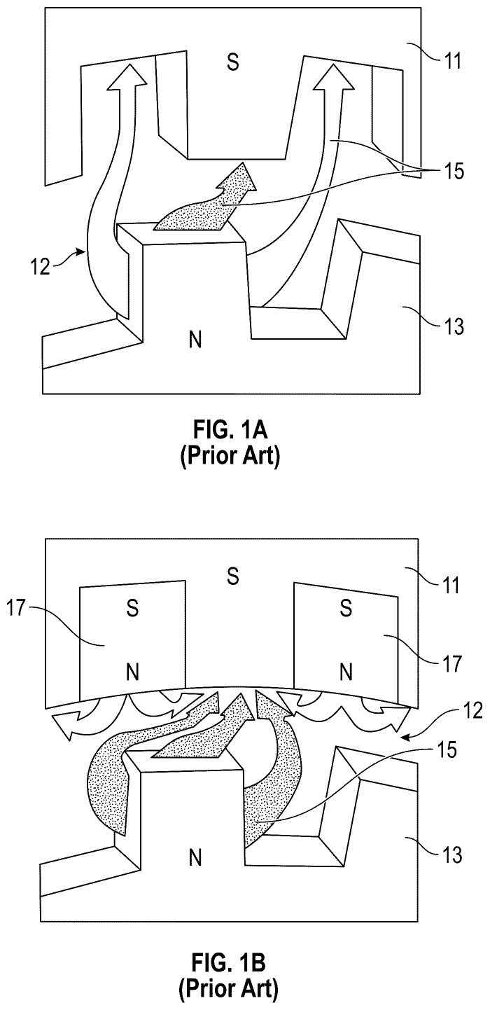

FIG. 2 is a schematic illustration of a rotor and stator interface representing those parameters that are relevant to calculating Carter's coefficient in the prior art.

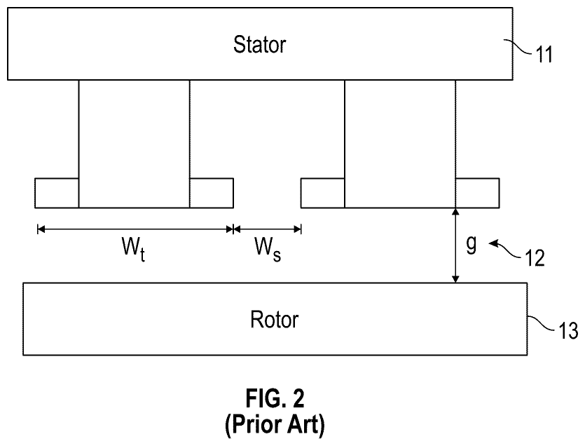

FIG. 3 is a perspective view of a prior art rotor for a hybrid stepper motor with two offset sets of axially oriented teeth (Z is the rotation axis of the rotor), showing surface slots into which magnetic pins can be inserted between the rotor teeth.

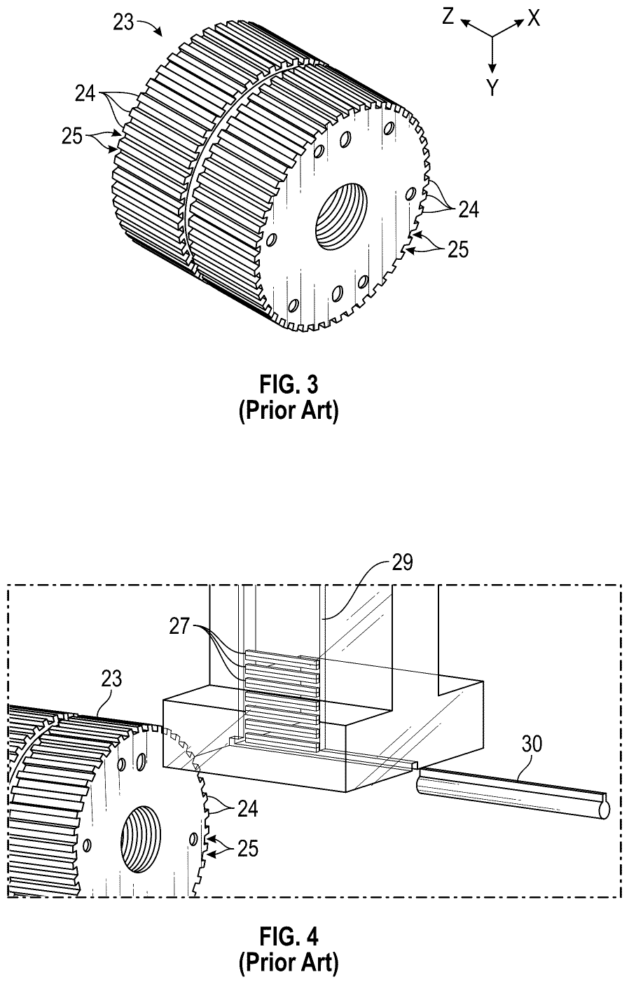

FIG. 4 is a schematic perspective view of a standard process of axial insertion of magnet pins into slots between teeth of a rotor as in FIG. 3, using a prior art mechanism in which a push rod slides each pin along a cartridge guide and axially into an positionally indexed inter-tooth slot.

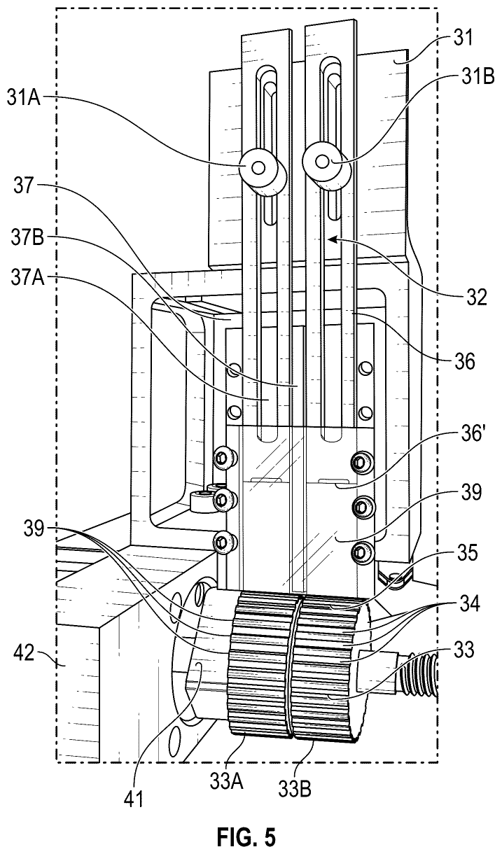

FIG. 5 is a schematic front perspective view of a magnetic pin insertion system in accord with the present invention, using elevational or radial insertion of magnet pins into inter-tooth slots of a workpiece here seen as a hybrid rotor). Note that both halves of the hybrid rotor workpiece are loaded simultaneously with magnetic pins fed from two adjacent cartridge chutes.

FIG. 6 is a close-up perspective view seen slightly from below of the magnetic pin insertion system of FIG. 5 that includes a rotor (or stator) workpiece motor drive and cartridge with one or more magnetic pin guide chutes for loading magnetic pins into inter-tooth workpiece slots. The adjustable tongue for shearing the fed magnetic pins from the pin stack is visible at the bottom of the cartridge chutes.

FIG. 7 is a close-up, mainly axial, perspective view of the workpiece receiving the pins from the bottom of a cartridge chute, as in FIG. 5.

FIGS. 8A through 8C are successive close-up axial side views showing magnetic pin insertion from a guide chute of a cartridge into one of the workpiece slots, and subsequent shearing from other magnetic pins remaining in the guide chute as the workpiece is continuously driven.

### DETAILED DESCRIPTION

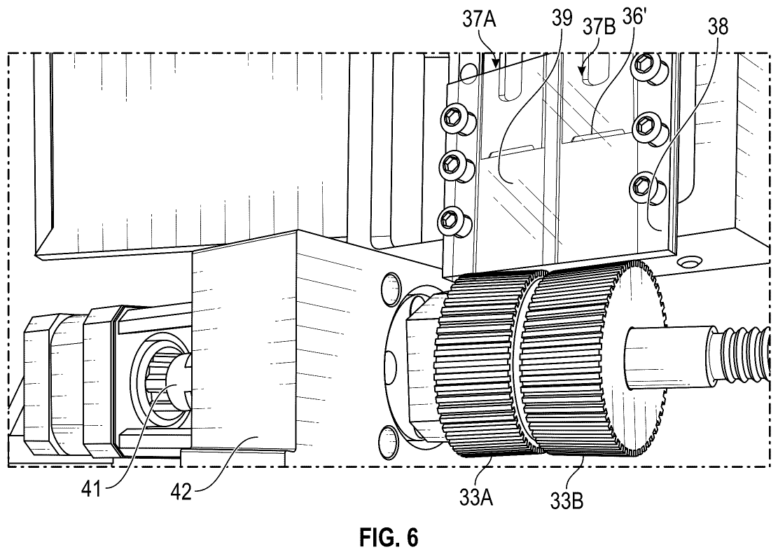

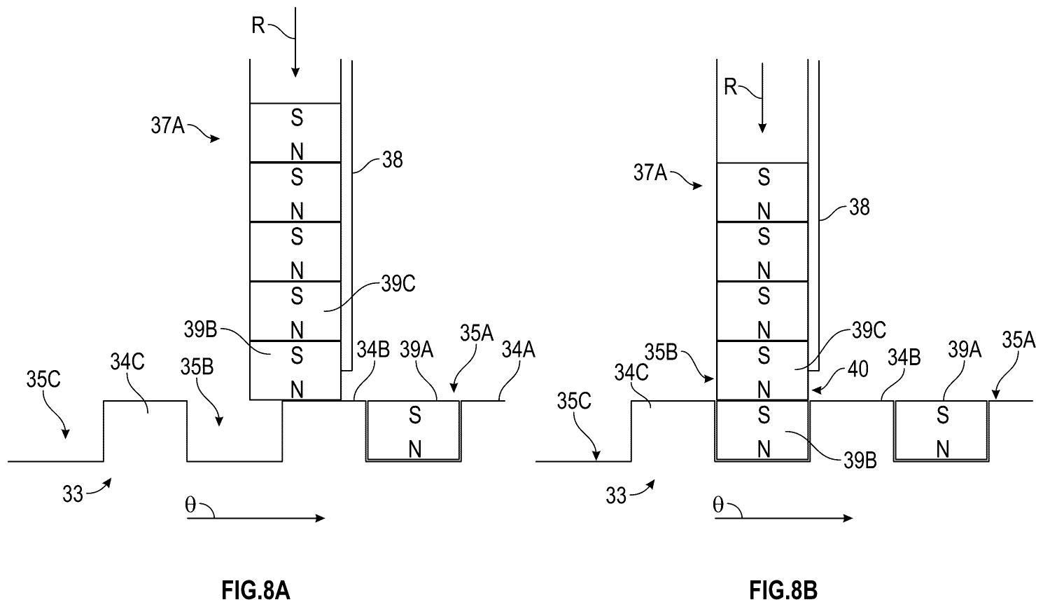

With reference to FIGS. 5-7, a magnetic pin insertion system for use in the manufacture of motors comprises a rotary drive 41 of a motor workpiece (rotor or stator) 33 and fixtures that place a cartridge 37 containing one or more chutes, e.g. 37A and 37B, with stacks of magnetic pins 39 directly over the rotor and/or stator tooth valleys (inter-tooth slots) 35.

In FIGS. 5-7, the workpiece 33 is represented by a hybrid rotor for a stepper motor. The rotor 33 has two sections 33A and 33B with offset sets of axially oriented teeth 34 and corresponding offset sets of inter-tooth slots or valleys 35. A cartridge 37 has one chute per workpiece section, and therefore in this case two chutes 37A and 37B, each of which can hold stacks of magnetic pins 39 to be successively loaded into the slots 35 as the pins 39 are fed from the cartridge 37. This invention replaces the customary axial insertion of magnetic pins into an elevational or radial insertion of magnetic pins 39 into the various slots 35 of the workpiece. Additionally, the invention replaces the requirement for precision indexing of workpiece rotational position with a continuous rotation of the workpiece 33 as magnetic pins 39 are fed from above as the successive slots 35 rotate into position.

As seen in FIG. 5, directly over the magnet cartridge 37 is either a pin feed mechanism in the form of a controlled mass (here, linear slide plate weights 36) that is used to ensure the magnet pins 39 inside the cartridge 37 are fed successively into the respective tooth valleys 35. Alternatively, a preloaded push spring could be used. Through precision fixturing and the controlled mass or load spring, the drive motor 41 can activate the axial turning of the rotor or stator workpiece 33 while each magnet pin 39 is automatically placed directly into the target tooth valley 35 and then separated from the other magnet pins 39 by shearing action against the adjustable tongues 38 on the cartridge guide rails or chutes 37A and 37B as the workpiece 33 continuously turns. With multiple magnet pin chutes 37A and 37B in the cartridge, both halves of the hybrid rotor, and even multiple rotors, or stators, can be situated under the cartridge 37 and loaded simultaneously with their respective pins 39.

Situated above the workpiece 33 is a magnetic pin cartridge 37 in the form of a precision machined hopper which guides and resists magnetic pins 39. The magnetic pins 39 are dropped down at least one guide chute (or more usually, simultaneously down multiple guide chutes 37A, 37B, . . . ) in the cartridge 37 via either gravity (preferably assisted by a weight placed above the stack of pins) or via spring load. The pins 39 in the stack slide between rails down their respective guide chutes into inter-tooth surface slots around the circumference of the workpiece 33. More specifically, an upright mounting plate 31 attached at the top of the cartridge 37 supports linear slide plate weights 36 in linear open slot races 32 with guide posts 31A and 31B for those races that allow the weights 36 to slide vertically in the chutes 37A and 37B. The bottom end 36′ of each slide plate weight 36 thereby pushes downward against a corresponding stack 39 of magnetic pins.

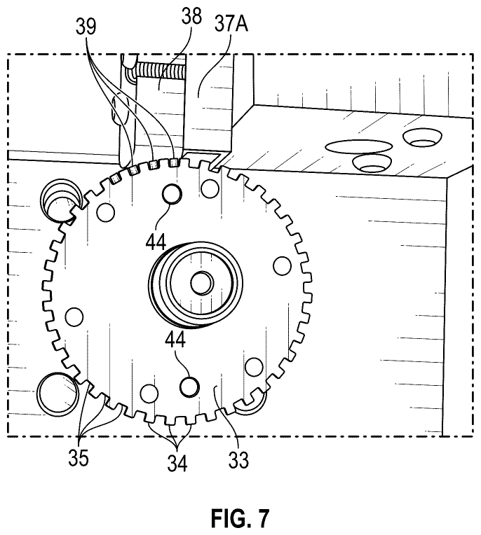

As seen more clearly in FIG. 6, a single rotary drive 41 with a workpiece mounting block 42 transfers rotational motion about a central axis to the motor workpiece 33 being assembled. The workpiece 33 is fixed to the rotary mount 42 so that it will axially align with the cartridge 37 and its several chutes 37A and 37B above. If desired, spacers with posts fitting into corresponding holes 44 in the ends of each workpiece 33 can allow multiple workpieces to be mounted to the rotary drive 41, so that more than one workpiece might be simultaneously loaded. In that case, the cartridge 37 would have as many chutes 37A, 37B, . . . as there are corresponding workpiece sections to be loaded with magnetic pins 39.

Although the motor workpiece in FIGS. 5-7 is, by way of example, a rotor 33, the workpiece might also be a stator receiving magnetic pins associated with stator pole teeth. This is easiest to accomplish in an interior stator and exterior rotor type motor, wherein the circumferential surface receiving the magnetic pins is an exterior surface of the stator, just as with the rotor. However, in the case of an interior rotor and exterior stator type motor, wherein it is the interior surface of the stator that needs to receive the magnetic pins, the workpiece can be attached at one end to the rotary drive in such a way that will leave enough space within the stator workpiece interior to accommodate the presence of the magnetic pin feed cartridge. A preloaded push spring feed mechanism for the stack of pins will ensure that the cartridge is not too tall to fit within the workpiece interior space. Thus, both types of stators can be loaded with magnetic pins using this type of radially pin loading setup.

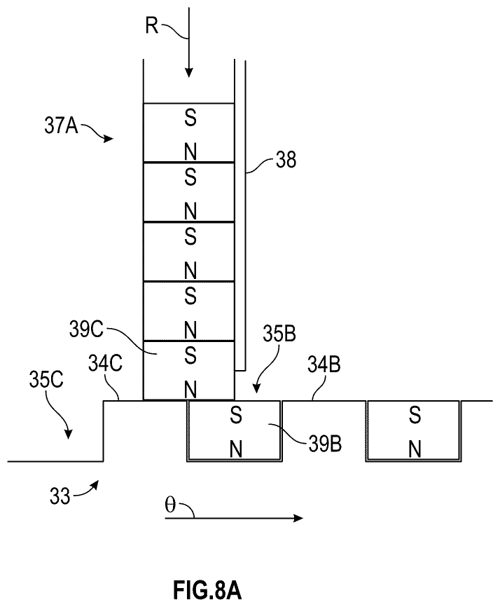

With reference to FIGS. 8A-8C, as rotary motion is applied to the rotor or stator workpiece 33 by the drive, represented by arrow 6 showing the movement of the teeth 34A, 34B, 34C, . . . and slots 35A, 35B, 35C, . . . past the chute 37A, the successive magnetic pins 39A, 39B, 39C, . . . from a stack within the cartridge chute 37A (and likewise from chute 37B, not seen) are sequentially fed into each successive slot 35A, 35B, 35C, . . . between the rotor or stator workpiece teeth 34A, 34B, 34C, . . . , which then shear away at the end of their chutes from the other pins still in the stack. The aforementioned weight or load spring helps to push the pins downward with a radial force R between rails along their guide chutes 37A, etc. to ensure the feeding of pins into their respective slots.

There is typically a 50 μm (0.002″) gap 40 (seen in FIG. 8B) between the end of the cartridge chute 37A etc. and the tops of the teeth 34A, 34B, 34C, . . . on the workpiece 33. The smallness of this gap 40, which is generally less than half of the thickness of each magnetic pin 39A, 39B, 39C, . . . , discourages any axial turning or twisting of pins as they are fed into their successive slots. To enforce the size of the gap, the several chutes 37A and 37B of the cartridge 37 preferably terminate in a mechanically adjustable tongue 38 that provides a resistive surface for shearing each pin away from other pins in the stack as that pin is pushed into its workpiece slot. Such tongues 38 (one for each chute) are adjusted, e.g. with knobs, so that their ends closest to the workpiece 33 have the desired gap 40 from the end of the cartridge chutes to the tops of the workpiece teeth.

After all pins have been successfully placed within their respective inter-tooth valleys, an adhesive is typically externally applied onto the workpiece using another rotary machine, as in prior methods.

What is claimed is:

1. A magnetic pin insertion system in the manufacture of motors, comprising:
a rotary drive of a workpiece being assembled for subsequent use in a motor, the rotary drive rotating the workpiece about an axis thereof, the workpiece having a set of axially oriented slots around a circumferential surface of the workpiece that are receptive of magnetic pins;
a cartridge with at least one chute, with each chute associated with a corresponding axial section of the workpiece and holding an axially oriented stack of magnetic pins in guide channels thereof, each chute of the cartridge also having a pre-loaded feed mechanism applied radially against the stack of magnetic pins to push the pins into successive slots of the workpiece as the rotary drive rotates the workpiece, each guide channel terminating in an adjustable tongue providing a resistive surface for shearing each pin away from other pins in the stack as the pin is pushed into its slot.

2. The magnetic pin insertion system as in claim 1, wherein the workpiece is a rotor.

3. The magnetic pin insertion system as in claim 2, wherein the workpiece is a hybrid rotor having two axially disposed sections with circumferentially offset slots, the cartridge having two chutes for simultaneously feeding both stacks of the pins into corresponding slots of the respective sections.

4. The magnetic pin insertion system as in claim 1, wherein the workpiece is a stator.

5. The magnetic pin insertion system as in claim 1, wherein the pre-loaded feed mechanism of each chute of the cartridge is a mass that pushes pins downward by gravity into slots of the workpiece situated below the cartridge.

6. The magnetic pin insertion system as in claim 1, wherein the pre-loaded feed mechanism of each chute of the cartridge is a push spring.

7. The magnetic pin insertion system as in claim 1, wherein a gap between an end of the adjustable tongue and a corresponding top of a slot of the workpiece is less than half of a thickness of each magnetic pin to discourage any axial turning or twisting of pins as they are fed into successive slots.

8. The magnetic pin insertion system as in claim 1, wherein the rotary drive accommodates multiple workpieces and there are, in one or more cartridges, as many chutes as the total number of corresponding axial sections of all workpieces on the rotary drive.

9. A method of assembly of a motor workpiece with magnetic pin inserts, comprising:
placing at least one motor workpiece onto a rotary drive, the rotary drive rotating the workpiece about an axis thereof, the workpiece having a set of axially oriented slots around a circumferential surface that are receptive of magnetic pins;
feeding magnetic pins from a cartridge with at least one chute, each chute of the cartridge associated with a corresponding axial section of the workpiece and holding an axially oriented stack of magnetic pins in guide channels of the chute, each chute of the cartridge also having a pre-loaded feed mechanism that pushes against the stack of magnetic pins and feeds the pins into successive slots of the workpiece as the rotary drive rotates the workpiece; and
shearing, as each pin is inserted into its slot, that pin away from other pins in its stack against a resistive surface of an adjustable tongue that terminates each guide channel of a chute at a specified gap distance from the motor workpiece.

10. The method as in claim 9, wherein the workpiece is a rotor.

11. The method as in claim 10, wherein the workpiece is a hybrid rotor having two axially disposed sections with circumferentially offset slots, stacks of pins from two chutes of the cartridge being simultaneously fed into the corresponding slots of the respective sections.

12. The method as in claim 9, wherein the workpiece is a stator.

13. The method as in claim 9, wherein the pre-loaded feed mechanism of each chute of the cartridge is a mass that pushes pins downward by gravity into slots of the workpiece situated below the cartridge.

14. The method as in claim 9, wherein the pre-loaded feed mechanism of each chute of the cartridge is a push spring.

15. The method as in claim 9, wherein the specified gap distance between the adjustable tongue and a corresponding top of a slot of the workpiece is less than half of a thickness of each magnetic pin to discourage any axial turning or twisting of pins as they are fed into successive slots.

16. The method as in claim 9, wherein multiple workpieces are placed onto the rotary drive for simultaneous rotation, and there are, in one or more cartridges, as many chutes as the total number of corresponding axial sections of all workpieces on the rotary drive.
